(19) United States
(12) Patent Application Publication
(10) Pub. No.: US 2026/0352132 A1
(43) Pub. Date: Nov. 5, 2026

(54) MULTIPLE BATTERY DRIVE SYSTEM

(71) Applicant: Also, Inc., Palo Alto, CA (US)

(72) Inventors: Adam Christopher Bender, San Francisco, CA (US); Rui Guan, Palo Alto, CA (US); Nikola Popov, Palo Alto, CA (US)

(73) Assignee: Also, Inc., Palo Alto, CA (US)

(21) Appl. No.: 19/486,646

(22) PCT Filed: May 31, 2024
(86) PCT No.: PCT/US2024/032138

§ 371 Date: Nov. 21, 2025

Related U.S. Application Data
(60) Provisional application No. 63/505,223, filed on May 31, 2023.

(51) Int. Cl. H02P 25/22; B60L 53/22; H02K 3/28

(52) U.S. Cl. CPC H02P 25/22; B60L 53/22; H02K 3/28; B60L 2200/12; H02P 2207/055

(57) ABSTRACT

An apparatus can include a first set of windings, coupled with a first battery via a first inverter. The apparatus can include a second set of windings, coupled with a second battery via a second inverter. The first inverter can be configured to provide first power of the first battery to the first set of windings during a time period. The second inverter can be configured to provide second power of the second battery to the second set of windings during the time period.

### CROSS-REFERENCE TO RELATED PATENT APPLICATION

The present application claims the benefit of and priority to U.S. Provisional Patent Application No. 63/505,223, filed May 31, 2023, the disclosure of which is incorporated herein by reference in its entirety.

### INTRODUCTION

A vehicle, such as an electric vehicle, can be driven by a motor. The motor can be powered by a battery.

### SUMMARY

At least one aspect is directed to an apparatus. The apparatus can include a first set of windings, coupled with a first battery via a first inverter. The apparatus can include a second set of windings, coupled with a second battery via a second inverter. The first inverter can be configured to provide first power of the first battery to the first set of windings during a time period. The second inverter configured to provide second power of the second battery to the second set of windings during the time period.

At least one aspect is directed to a method. The method can include coupling a first set of windings with a first battery via a first inverter. The method can include coupling a second set of windings with a second battery via a second inverter. The method can include providing, by the first inverter, first power of the first battery to the first set of windings during a time period. The method can include providing, by the second inverter, second power of the second battery to the second set of windings during the time period.

At least one aspect is directed to a motor. The motor can include a first set of windings, coupled with a first battery via a first inverter, the first set of windings to receive first power of the first battery from the first inverter during a time period. The motor can include a second set of windings, coupled with a second battery via a second inverter, the second set of windings to receive second power of the second battery from the second inverter during the time period.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example system of a vehicle that powers a motor with multiple batteries.

FIG. 2 depicts an example stator of a motor with a first set of windings for a first battery and a second set of windings for a second battery.

FIG. 3 depicts an example motor including a stator with a first set of windings for a first battery and a second set of windings for a second battery.

FIG. 4 depicts another example motor including a stator with a first set of windings for a first battery and a second set of windings for a second battery.

FIG. 5 depicts an example motor including a first stator for a first battery and a second stator for a second battery.

FIG. 6 depicts another example motor including a first stator for a first battery and a second stator for a second battery.

FIG. 7 depicts an electric bicycle including a system that powers a motor of the electric bicycle with multiple batteries.

FIG. 8 depicts an example method of operating a motor of a vehicle with multiple batteries.

FIG. 9 depicts an architecture for a controller that can be employed to implement elements of the systems and methods described and illustrated herein.

### DETAILED DESCRIPTION

Following below are more detailed descriptions of various concepts related to, and implementations of, methods, apparatuses, and systems of a multiple battery drive system. The various concepts introduced above and discussed in greater detail below may be implemented in any of numerous ways. The drive system described herein can be applied to systems with two batteries, three batteries, four batteries, or any number of batteries.

This disclosure is generally directed to techniques for operating a motor of a micro-vehicle with multiple battery packs. Micro-vehicles, such as electric bicycles or bikes, electric scooters, electric skateboards, or electric one-wheels, can have one or multiple batteries or battery packs. Because the battery packs can be at different states of charge, and have different voltages, if two battery packs are connected in parallel for simultaneous use, one battery can short into the other battery. Even if both battery packs are fully charged, the different characteristic of the battery packs can cause battery packs to discharge at different rates, and therefore, even if the voltage of the battery packs is the same at one point in time, at a future time, the voltages may be different and one battery pack can short into another battery pack. Therefore, vehicles with multiple battery packs can use the battery packs one at a time, and not simultaneously.

In this regard, the torque of a motor of the vehicle can be limited by the current output that a single battery pack can provide the motor. For example, a vehicle can switch back and forth from utilizing a first battery pack to drive a motor and utilizing a second battery pack to drive the motor instead of utilizing both battery packs simultaneously. The vehicle can begin utilizing a battery pack with the greatest state of charge or highest output voltage. The vehicle can continue utilizing that battery pack until the state of charge or voltage of the battery pack becomes less than another battery pack. Then, the vehicle can switch from utilizing the first battery pack to utilizing the second battery pack. The battery packs that are not being used by the vehicle can provide range extension for the vehicle, but cannot provide any additional power boost or torque boost for the motor.

To solve these and other technical problems, the present solution can include a dual or multiple battery drive system that can be driven by two battery packs at once (e.g., simultaneously, concurrently, concomitantly, together, or during a common operating period of time). A single motor can include a first set of windings and a second set of windings. The first set of windings and the second set of windings can be electrically isolated. However, the first set of windings and the second set of windings can be part of the same magnetic circuit that causes a rotor of the motor to spin, rotate, or revolve. The first set of windings can include three windings for three phases of an alternating current (AC) signal. The second set of windings can include three windings for three phases of a second AC signal.

The motor can include dual or multiple windings on a single stator. For example, the stator can include slots for the windings. The slots of the stator can include dual or multiple windings, for example, the slots can include windings of the first set of windings and windings of the second set of windings. Furthermore, the motor can include multiple stators, one stator for each set of windings. For example, the motor could include a first stator with the first windings and a second stator with the second windings. The first and second stators can be stacked or aligned axially, e.g., along a common longitudinal axis.

The first set of windings can be electrically coupled with the first battery pack. The first set of windings can be electrically coupled with the first battery pack through a first inverter of a controller. The output of the first inverter can connect to the first set of windings. The second set of windings can be electrically coupled with the second battery pack. The second set of windings can be electrically coupled with the second battery pack through a second inverter of the controller. The output of the second inverter can connect to the second set of windings. The first battery pack and the second battery pack can feed to a single controller. The controller can have the two inverter power stages and control the inverter power stages with a data processing system, microprocessor, microcontroller, or analog control circuit.

The motor can be driven by first power provided by the first battery pack and second power provided by the second battery pack simultaneously, concurrently, or during the same time period. Because the first battery pack and the second battery pack are not directly electrically coupled, the two battery packs can concurrently provide power to the first winding and the second winding respectively to drive the motor. In this regard, even if the two battery packs are at different states of charge, the battery packs can be used to simultaneously to drive a single motor.

By operating the motor with two battery packs simultaneously, the controller can operate the motor to provide increased power or torque. By using both battery packs simultaneously, the drive train of the vehicle can operate with an increased level of power. This can assist a rider, user, or driver in accelerating, starting from a stop, or climbing a hill. The simultaneous use of multiple batteries to power the motor can allow the vehicle to drive at a faster rate. Furthermore, the controller can control the power provided by each battery pack to the motor such that the range of the vehicle and the torque of the motor to be extended, optimized, increased, or improved. In this regard, this technical solution can allow for multiple batteries to be used together, even if there is a mismatch in state of charge of the batteries, to provide a higher power output and greater performance than using a single battery.

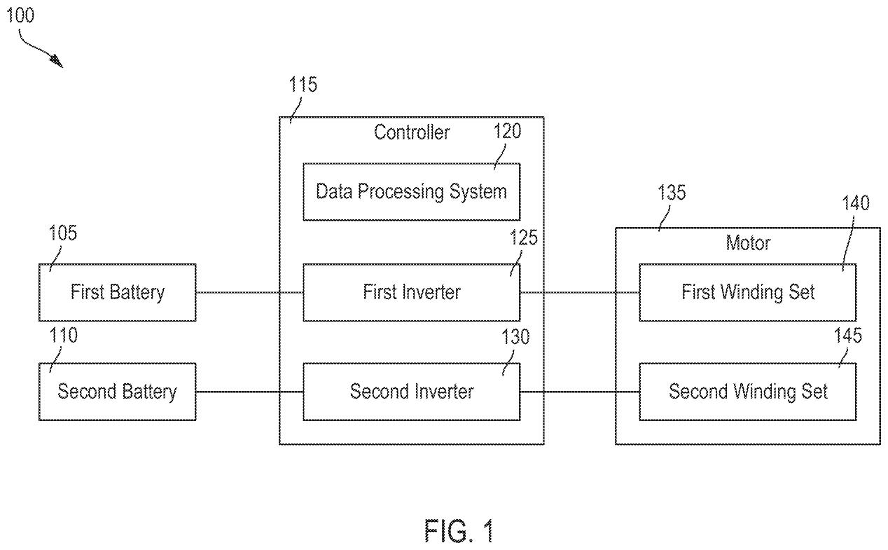

Referring now to FIG. 1, among others, a system 100 of a vehicle that powers a motor 135 with multiple batteries is shown. The system 100 can be a system, apparatus, or device. The system 100 can be a vehicle or can be a system of a vehicle. The vehicle can be an electric bike (two wheel bicycle, unicycle, tricycle), an electric scooter, an electric skateboard, an electric one-wheel. The vehicle can be an electric car, electric truck, electric delivery vehicle, electric semi-truck, electric boat, electric submarine, an electric drone or plane, an electric helicopter.

The system 100 can include at least one first battery 105 and at least one second battery 110. The first battery 105 and the second battery 110 can be separate battery cells, separate battery modules, or separate battery packs. The first battery 105 and the second battery 110 can have the same or different states of charge, or different capacities. The first battery 105 and the second battery 110 can be or include lithium-ion batteries that include an LFP (lithium iron phosphate) chemistry, an LMFP (lithium manganese iron phosphate) chemistry, an NMC (Nickel Manganese Cobalt) chemistry, an NCA (Nickel Cobalt Aluminum) chemistry, an OLO (Over Lithiated Oxide) chemistry, or an LCO (lithium cobalt oxide) chemistry for a cathode layer. The battery 105 or the battery 110 can include lithium-ion batteries that can include a graphite chemistry, a silicon-graphite chemistry, or a lithium metal chemistry for the anode layer). The first battery 105 and the second battery 110 can have the same or different chemical compositions. The first battery 105 and the second battery 110 can include the same number or a different number of battery cells or battery modules. The first battery 105 and the second battery 110 can include the same or different capacities.

The system 100 can include at least one controller 115. The controller 115 can include at least one data processing system 120. The data processing system 120 can be or include at least one processor, memory device, microcontroller, processor, microprocessor, logic circuit, or set of logic gates. The controller can include at least one first inverter 125 and at least one second inverter 130. The first inverter 125 and the second inverter 130 can control the delivery of power to the motor 135. The first inverter 125 and the second inverter 130 can control the frequency of power supplied to the motor 135. The first inverter 125 and the second inverter 130 can control whether the motor 135 rotates. The first inverter 1235 and the second inverter 130 can control the speed at which the motor 135 rotates. The first inverter 125 and the second inverter 130 can control a torque provided by the motor 135.

The first battery 105 can be coupled, connected, electrically coupled, or attached to the controller 115. The second battery 110 can be coupled, connected, electrically coupled, or attached to the controller 115. For example, at least one wire, cable, busbar, switch, or electrical component can couple the first battery 105 with the first inverter 125. At least one wire, cable, busbar, switch, or electrical component can couple the second battery 110 with the second inverter 130.

The first inverter 125 and the second inverter 130 can convert a direct current (DC) signal into an alternative current (AC) signal. For example the first inverter 125 can convert a first DC signal or first DC power received from the first battery 105 into a first AC signal or first AC power. The first AC signal can be a square wave, a sine wave, a sinusoidal pulse wave modulated (PWM) signal. The second inverter 130 can convert a second DC signal or second DC power received from the second battery 110 into a second AC signal or second AC power. The second AC signal can be a square wave, a sine wave, a sinusoidal pulse wave modulated (PWM) signal. The first inverter 125 can provide the first AC signal or first AC power to the motor 135. The second inverter 130 can provide the second AC signal or second AC power to the motor 135. The first inverter 125 and the second inverter 130 can each include rectifiers, smoothing units or filters, or inverter units.

The data processing system 120 can control, operate, or adjust the first inverter 125 and the second inverter 130. For example, the data processing system 120 can control the frequency of the first AC signal generated by the first inverter 125. The data processing system 120 can control the frequency of the second AC signal generated by the second inverter 130. The data processing system 120 can control, adjust, or output at least one voltage, current, pulse wave modulated (PWM) signal that controls the first inverter 125 and the second inverter 130. The data processing system can provide a first output signal to the first inverter 125 to control the frequency of the first AC signal output by the first inverter. The data processing system can provide a second output signal to the second inverter 130 to control the frequency of the first AC signal output by the first inverter.

The system 100 can include at least one motor 135. The motor 135 can be an AC or DC motor. The motor 135 can be a synchronous motor or an induction motor, such as a single phase induction motor or a three phase induction motor. The motor can include at least one first winding set 140 and at least one second winding set 145. The first winding set 140 (or first set of windings) can be coupled with the first battery 105 via the first inverter 125. The second winding set 145 (or second set of windings) can be coupled with the second battery 110 via the second inverter 130. Both the first winding set 140 and the second winding set 145 can be disposed within a single motor 135, e.g., within an enclosure, case, or housing of the motor 135. Furthermore, the first winding set 140 and the second winding set 145 can simultaneously or concurrently conduct current within the motor or within a magnetic field of the motor 135. A rotor of the motor or drive shaft of the motor can be rotated, turned, or spun by the first winding set 140 and the second winding set 145.

The first winding set 140 can include one or multiple windings, such as a first windings for a first phase of an AC signal, a second windings for a second phase of an AC signal, or a third set of windings for a third phase of a an AC signal. The second winding set 145 can include one or multiple windings, such as a first set of windings for a first phase of an AC signal, a second set of windings for a second phase of an AC signal, or a third set of windings for a third phase of a an AC signal. For example, the first AC signal output by the first inverter 125 can be a 3-phase signal. The second AC signal output by the second inverter 130 can be a 3-phase signal. Each phase of the phases of the first AC signal can be provided by the first inverter 125 to one of the windings of the first winding set 140. Each phase of the phases of the second AC signal can be provided by the second inverter 130 to one of the windings of the second winding set 145.

The first winding set 140 can be electrically coupled, connected, or attached to the first inverter 125. For example, an output of the first inverter 125 can be coupled to an input of the first winding set 140. The first inverter 125 can output a first AC signal with one or multiple phases. A first phase of the first AC signal can be coupled with first windings of the first winding set 140, a second phase of the first AC signal can be coupled with second windings of the first winding set 140, and a third phase of the first AC signal can be coupled with the third windings of the first winding set 140. The second winding set 145 can be electrically coupled, connected, or attached to the second inverter 130. For example, an output of the second inverter 130 can be coupled to an input of the second winding set 145. The second inverter 130 can output a second AC signal with one or multiple phases. A first phase of the second AC signal can be coupled with first windings of the second winding set 145, a second phase of the second AC signal can be coupled with second windings of the second winding set 145, and a third phase of the second AC signal can be coupled with the third windings of the second winding set 145.

The first inverter 125 and the second inverter 130 can simultaneously or concurrently provide power or current to the motor 135. For example, the first inverter 125 can provide first power of the first battery 105 to the first winding set 140 during a time period and the second inverter 130 can provide second power of the second battery 110 to the second winding set 145 during the same time period. Providing the first power to the first winding set 140 and the second power to the second winding set 145 during the time period can include simultaneously or concurrently providing the first power to the first winding set 140 and the second power to the second winding set 145 for at least one point in time or at least one portion of time of the time period. For example, the first inverter 125 can provide the first power to the first winding set 140 during the entire duration of the time period and the second inverter 130 can provide the second power to the second winding set 145 during the entire duration of the time period. For example, the first inverter 125 and the second inverter 130 can simultaneously or concurrently provide a first AC signal or first AC power to the first winding set 140 and a second AC signal or second AC power to the second winding set 145.

The electrical circuits of the first battery 105, the first inverter 125, and the first winding set 140 can be electrically separate, or partially separate, from the electrical circuits of the second battery 110, the second inverter 130, and the second winding set 145. In this regard, the first battery 105 and the second battery 110 can be decoupled and not discharge or short into each other. However, because the power of the first battery 105 and the second battery 110 are provided to separate winding sets 140 and 145, the first inverter 125 and the second inverter 130 can power or drive the motor 135 with both of the batteries 105 and 110 simultaneously regardless of the state of charge or battery voltage of the batteries 105 and 110. For example, the first inverter 125 can provide first power of the first winding set 140 to the first battery 105 and the second inverter 130 can provide second power of the second battery 110 to the second winding set 145 when the first battery 105 and the second battery 110 are at the same state of charge or approximately at the same state of charge and when the first battery 105 and the second battery 110 are at different states of charge.

If the controller 115 operates the motor 135 with only the first battery 105 or only the second battery 110, the vehicle can have a first range or total distance that the vehicle can travel. Furthermore, the motor 135 can provide a first torque or first maximum torque level to drive the vehicle. However, by simultaneously driving the first winding set 140 based on power of the first battery 105 and the second winding set 145 based on power of the second battery 110, torque that the motor 135 can output or provide can be increased, e.g., a maximum level of torque of the motor 135 can be increased. Furthermore, the total range of the vehicle can be increased.

The controller 115 can receive measurements or characteristics of the first battery 105 and the second battery 110. For example, the controller 115 can receive measurements from sensors of the first battery 105 or the second battery 110. For example, the controller 115 can receive a first voltage of the first battery 105 from a voltage sensor of the first battery 105. The controller 115 can receive a first temperature of the first battery 105 from a first temperature sensor of the first battery 105. The controller 115 can determine or measure a first state of charge of the first battery 105 via one or multiple first sensor measurements of one or multiple first sensors of the first battery 105. Furthermore, the controller 115 can receive a second voltage of the second battery 110 from a second voltage sensor of the second battery 110. The controller 115 can receive a second temperature of the second battery 110 from a second temperature sensor of the second battery 110. The controller 115 can determine or measure a second state of charge of the second battery 110 via one or multiple second sensor measurements of one or multiple second sensors of the second battery 110.

The controller 115 can use the characteristics of the first battery 105 and the second battery 110 to determine a frequency of the first AC signal for the first inverter 125 to provide to the first winding set 140 and a frequency of the second AC signal for the second inverter 130 to provide to the second winding set 145. The controller 115 can determine, based on an optimization or control algorithm, a frequency to provide to the first winding set 140 and a frequency to provide to the second winding set 145 to increase, boost, maximize, or optimize the torque of the motor 135 or the range of the vehicle. The controller 115 can detect, based on feedback data or sensor data of the motor 135, to increase the torque of the motor 135 by control the frequency or amplitude of the AC signal provided to the first winding set 140 or the second winding set 145.

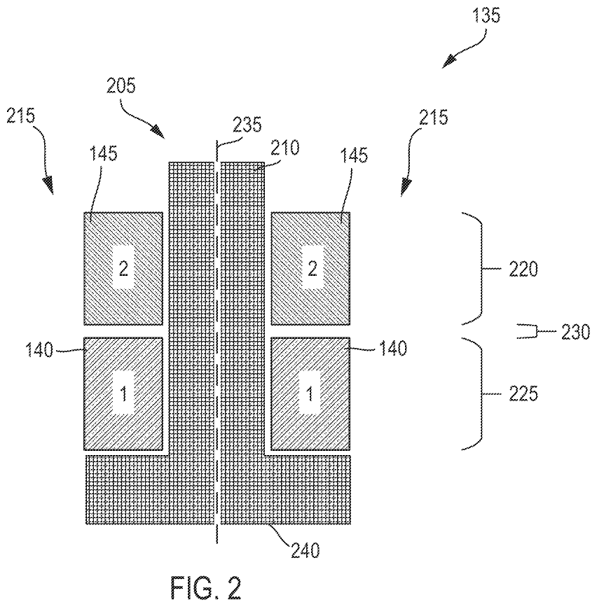

Referring now to FIG. 2, a stator 205 of a motor 135 with a first set of windings 140 for the first battery 105 and a second set of windings 145 for the second battery 110 is shown. The stator 205 can include at least one slot 215. The slots 215 can be cutaways, grooves, openings, or spaces between members 210 of the stator 205. The members 210 can be cylinder shaped, rectangular solid shaped, pole shaped, spoke shaped, or free form shaped. The windings of the first winding set 140 and the windings of the second winding set 145 can be wound in the slots 215 between the members 210. At least one winding of the first winding set 140 and at least one winding of the second winding set 145 can be wound at least partially around the members 210.

The windings of the first winding set 140 can be wound over a length, section, or area 225 of the member 210. For example, the windings of the first winding set 140 can be wound over a length along the longitudinal axis 235 of the member 210. The windings of the second winding set 145 can be wound over a length or area 220 of the member 210. The first winding set 140 and the second winding set 145 can be separated by a length or distance 230. The first winding set 140 and the second winding set 145 may not be separated by any distance at all. The second length 220 and the first length 225 can be the same length or different lengths. The second length 220 and the first length 225 can be one inch to three inches. The second length 220 and the first length 225 can be half an inch to three and a half inches. The second length 220 and the first length 225 can be a quarter inch to four inches. The distance 230 can be an eighth inch to a quarter inch long. The distance 230 can be a sixteenth inch to a half inch long. The distance 230 can be less than a sixteenth inch or greater than a half inch.

The first area 225 can be positioned a first distance from an end 240. The second area 220 can be positioned a second distance from the end 240. The end 240 can be an end, edge, or outer surface of the member 210. The first area 225 can be positioned a first distance from the end 240 of the stator 205, which can be a shorter distance than a second distance that the second area 220 is positioned from the end 240 of the stator 205. The second distance that the second area 220 is positioned from the end 240 of the stator 205 can be greater than a first distance than the first area 225 is positioned from the end 240 of the stator 205.

In some implementations, the first winding set 140 and the second winding set 145 are wound over the same area, length, or section of the member 210. For example, the first winding set 140 and the second winding set 145 can be wound together and overlap each other over a section of the member 210. For example, the first windings 140 could be wound first and the second set of windings 145 wound over the first windings 140. For example, the first windings 140 and the second set of windings 145 can be mixed together and overlap each other. In some implementations, the winding sets 140 and/or 145 can have non-conductive coatings or insulators (such as a thermoplastic compound or thermoplastic rubber) so that the windings 140 and 145 are electrically separate.

The gauge of the wire of the first winding set 140 and the wire of the second winding set 145 can be different, the same, or approximately the same. The gauge of the wires of the first winding set 225 and the second winding set 220 can be based, selected, or disposed in the motor 135 based on a capacity of the first battery 105 and the second battery 110 and/or based on nominal or maximum current level that the batteries 105 and 110 provide. For example, the larger the capacity of the first battery 105 and the second battery 110, and the greater the amount the current that the first battery 105 and the second battery 110 can provide, the lower the gauge of the wires of the first winding set 140 and the second winding set 145. Because the first battery 105 and the second battery 110 can be different capacities and provide different amounts of current, the gauge of the first winding set 140 and the gauge of the second winding set 145 can be different, e.g., the gauge of wires of the first winding set 140 can be lower than the gauge of wires of the second winding set 145 if the first battery 105 has a higher capacity than the second battery 110.

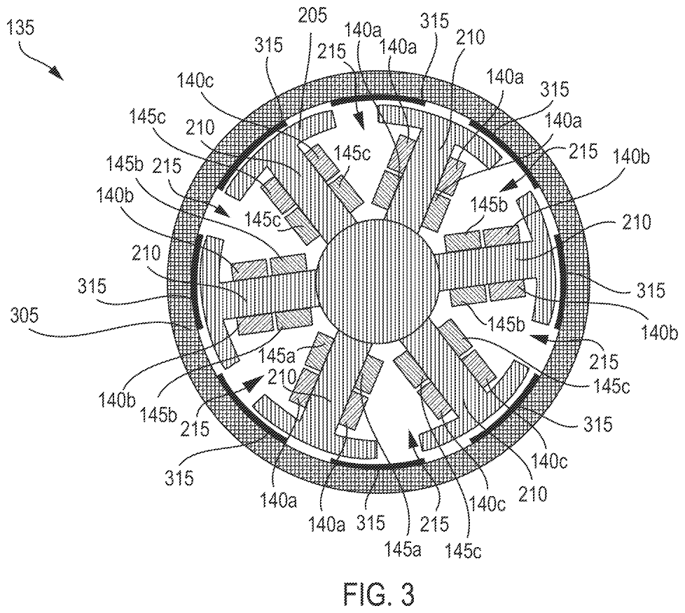

Referring now to FIG. 3, among others, the motor 135 including a stator 205 with the first set of windings 140 for the first battery 105 and the second set of windings 145 for a second battery 110 is shown. The motor 135 can include at least one rotor 305. The rotor 305 can be cylindrically shaped. The rotor 305 can be ring shaped. The rotor 305 can include a hollow inner portion, e.g., a cylindrically shaped cavity, space, or open area. The rotor 305 can circumscribe, encircle, or surround at least a portion of the stator 205. For example, the rotor 305 can be disposed within the inner cylindrical shaped cavity of the rotor 305. The rotor 305 can include at least one magnet 315. The magnets 315 can be disposes on the inner surface of the rotor 305. For example, the magnets 315 can include a curved surface the conforms with the curved inner surface of the rotor 305. The magnets 315 can include ceramic magnets, alnico magnetics, neodymium magnets, samarium cobalt magnets, etc. The magnets 315 can be disposed and spaced around the inner surface of the rotor 305 and surround at least a portion of the stator 205. The magnets 315 can create a magnetic field within the motor 135.

The first inverter 125 can provide first power of the first battery 105 to the first winding set 140 and the second inventor 130 can provide second power of the second battery 110 to the second winding set 145. The current that flows through the first winding set 140 and the second winding set 145 in the motor 135 can cause the rotor 205 to rotate. For example, a current that runs through the first winding set 140 and the second winding set 145 within the magnetic field created by the magnets 315 can cause the rotor 305 to rotate, spin, accelerate, decelerate, or turn. The rotor 305 can rotate responsive to current flowing through one of the first winding set 140 and the second winding set 145. The rotor 305 can rotate responsive to first current flowing in the first winding set 140 and second current simultaneously or concurrently flowing in the second winding set 145.

The motor 135 can include multiple members 210 that each include windings of the first winding set 140 and the second winding set 145 that conduct a particular phase of the first AC signal or the second AC signal. At least two members 210 can include windings of the first winding set 140 and winding of the second winding set 145 that conduct current of a particular phase of the first AC signal or the second AC signal. The windings of each member 210 can conduct a current of one phase of a 3-phase AC signal. The first winding set 140 can include windings 140a for a first phase of the first AC signal, windings 140b for a second phase of the first AC signal, and windings 140c for a third phase of the first AC signal. The second winding set 145 can include windings 145a for a first phase of the second AC signal, windings 145b for a second phase of the second AC signal, and windings 145c for a third phase of the second AC signal.

For example, the first inverter 125 can apply or provide a first phase of the first AC signal to the windings 140a. The first inverter 125 can couple the first phase of the first AC signal with the windings 140a such that a voltage of the first phase of the first AC signal can be provided to the windings 140a and that the windings 140a conduct current of the first phase of the first AC signal. Furthermore, the first inverter 125 can apply or provide a second phase of the first AC signal to the windings 140b. The first inverter 125 can couple the second phase of the first AC signal with the windings 140b such that a voltage of the second phase of the first AC signal can be provided to the windings 140b and that the windings 140b conduct current of the second phase of the first AC signal. Furthermore, the first inverter 125 can apply or provide a third phase of the first AC signal to the windings 140c. The first inverter 125 can couple the third phase of the first AC signal with the windings 140c such that a voltage of the third phase of the first AC signal can be provided to the windings 140c and that the windings 140c conduct current of the third phase of the first AC signal.

For example, the second inverter 130 can apply or provide a first phase of the second AC signal to the windings 145a. The second inverter 130 can couple the first phase of the second AC signal with the windings 145a such that a voltage of the first phase of the second AC signal can be provided to the windings 145a and that the windings 145a conduct current of the first phase of the second AC signal. Furthermore, the second inverter 130 can apply or provide a second phase of the second AC signal to the windings 145b. The second inverter 130 can couple the second phase of the second AC signal with the windings 145b such that a voltage of the second phase of the second AC signal can be provided to the windings 145b and that the windings 145b conduct current of the second phase of the second AC signal. Furthermore, the second inverter 130 can apply or provide a third phase of the second AC signal to the windings 145c. The second inverter 130 can couple the third phase of the second AC signal with the windings 145c such that a voltage of the third phase of the second AC signal can be provided to the windings 145c and that the windings 145c conduct current of the third phase of the second AC signal.

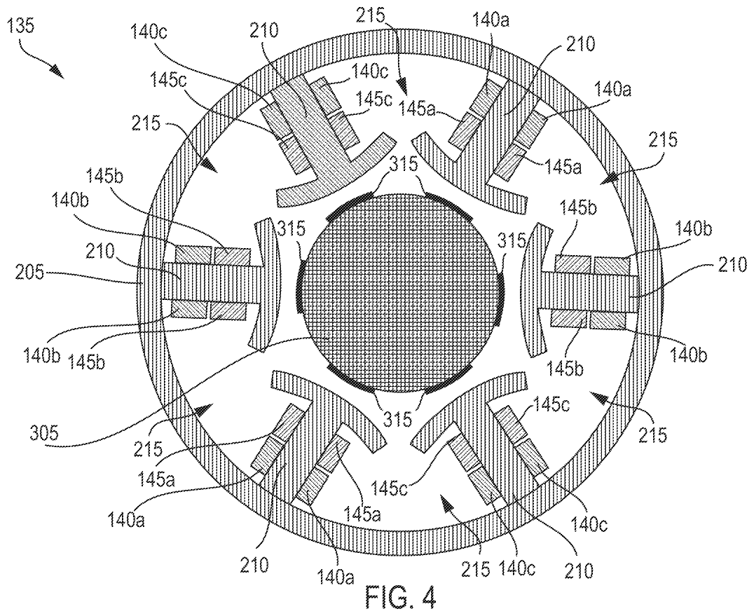

Referring now to FIG. 4, among others, the motor 135 including the stator 205 with the first set of windings 140 for the first battery 105 and the second set of windings 145 for the second battery 110 is shown. The rotor 305 can be a cylindrical shape, e.g., a solid cylindrical shape. The rotor 305 can be disposed within, or fit within, the stator 205. For example, the rotor 305 can be disposed within or fit within ends 240 of the members 210 of the stator 205. The first AC signal can be applied or provided by the first inverter 125 to the first winding set 140 and the second AC signal can simultaneously be applied or provided by the second inverter 130 to cause the rotor 305 to rotate, spin, accelerate, decelerate, or move within the stator 205.

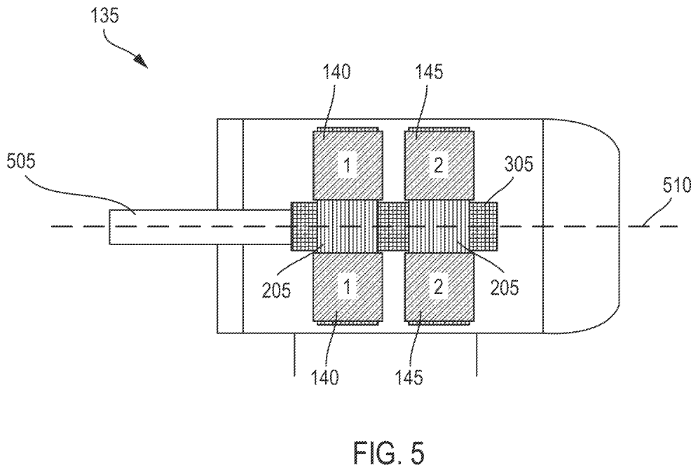

Referring now to FIG. 5, among others, the motor 135 including a first stator 205 for a first battery 105 and a second stator 205 for a second battery 110 is shown. The motor 135 can include at least two stators 205. For example, the motor 135 can include one, two, three, four, or any number of stators 205. The motor 135 can include a stator 205 for each battery of the system 100, e.g., a first stator 205 for the first battery 105, a second stator 205 for the second battery 110, a third stator for a third battery.

In FIG. 5, the rotor 305 can fit within cavities of the first stator 205 and the second stator 205. For example, the first stator 205 and the second stator 205 can each include a cavity. The cavity can be a cylindrical shaped cavity. The rotor 305 can fit within the cavity of the first stator 205 and the second stator 205. The magnets 315 of the rotor 305 can be disposed on the rotor 305 such that the magnets 315 are positioned within the first stator 205 and the second stator 205. Furthermore, first magnets 315 can be disposed on the rotor 305 within the first stator 205, and second magnets 315 can be disposed on the rotor 305 within the second stator 205. The rotor 305 can rotate, spin, or turn within the first stator 205 and the second stator 205.

The motor 135 can include a shaft 505. The shaft 505 can be coupled, fixed, fixedly coupled, or connected with the rotor 305. The shaft 505 can be coupled with a tractive component, device, or apparatus of a vehicle that causes the vehicle to translate, transport, or drive forward, reverse, turn, or brake. The tractive component can be a wheel, a belt, a chain, or a propeller. The shaft 505 can be or include a pole, beam, or member. The shaft 505 can have a cylindrical shape, a rectangular solid shape, a triangular shape. The shaft 505 can be rotated by the rotation of the rotor 305. The shaft 505 can rotate with the rotor 305 such that the shaft 505 rotates in the same direction as the rotor 305. The rotation of the rotor 305 can turn the shaft 505 and actuate the tractive component of the vehicle.

The motor 135 can include a longitudinal axis 510. The longitudinal axis 510 can be shared by the shaft 505 and the rotor 305. For example, a longitudinal axis 510 of the shaft 505 and the longitudinal axis 510 of the rotor 305 can be aligned or shared. Furthermore, the first stator 205 and the second stator 205 can each have a longitudinal axis 510. For example, the first stator 205 can include a first longitudinal axis 510 and the second stator 205 can include a second longitudinal axis 510. The first longitudinal axis 510 and the second longitudinal axis 510 can be aligned. The longitudinal axis 510 of the first stator 205 can be the same longitudinal axis 510 of the second stator 205. In this regard, the first stator 205 and the second stator 205 can be axially stacked. For example, the first stator 205 and the second stator 205 can have longitudinal axes 510 that are aligned. The first stator 205 and the second stator 205 can share the same longitudinal axis 510 or each have a common longitudinal axis 510.

The first winding set 140 and the second winding set 145 can be coupled with the first stator 205 and the second stator 205 respectively. For example, the first winding set 140 can be coupled with the first stator 205. The second winding set 145 can be coupled with the second stator 205. The first winding set 140 can be wound on members, poles, spokes, or shafts of the first winding 140. The first winding set 140 can be wound in slots of the first stator 205. The first winding set 140 can include three windings, one for each phase of the first AC signal. At least one of the three windings of the first winding set 140 can be coupled with the first stator 205. The second winding set 145 can be wound on members, poles, spokes, or shafts of the second winding 145. The second winding set 145 can be wound in slots of the second stator 205. The second winding set 145 can include three windings, one for each phase of the second AC signal. At least one of the three windings of the second winding set 145 can be coupled with the second stator 205.

Even though the first winding set 140 and the second winding set 145 are wound on separate stators 205, the first winding set 140 and the second winding set 145 can simultaneously or concurrently conduct current of the first and second AC signals respectively. The first winding set 140 can conduct current of the first AC signal and the second winding set 145 can conduct current of the second AC signal. By simultaneously conducting current, the first winding 140 and the second winding 145 can both cause the rotor 305 to rotate, spin, turn, or move. The controller 115 can control the first inverter 125 and the second inverter 130 to simultaneously provide power to the first set of windings 140 and the second set of windings 145.

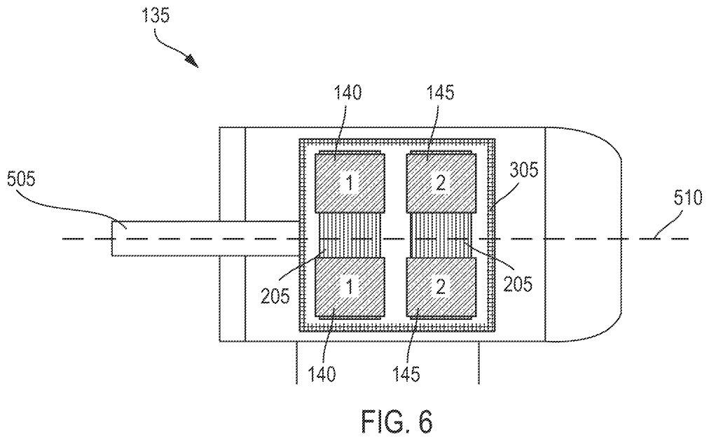

Referring now to FIG. 6, among others, the motor 135 including the first stator 205 for the first battery 105 and the second stator 205 for the second battery 110 is shown. In FIG. 6, the rotor 305 can be disposed within the motor 135 around the first stator 205 and the second stator 205. For example, the rotor 305 can be disposed around the first stator 205 and the second stator 205. For example, the rotor 305 can include a cavity or opening. The first stator 205 and the second stator 205 can fit within the cavity or opening of the rotor 305. For example, the first inverter 125 can provide the first AC signal to the first winding set 140 of the first stator 205 and the second inverter 130 can simultaneously provide the second AC signal to the second winding set 145 of the first stator 205 to cause the rotor 305 to rotate, spin, turn, or move about the first stator 205 and the second stator 205.

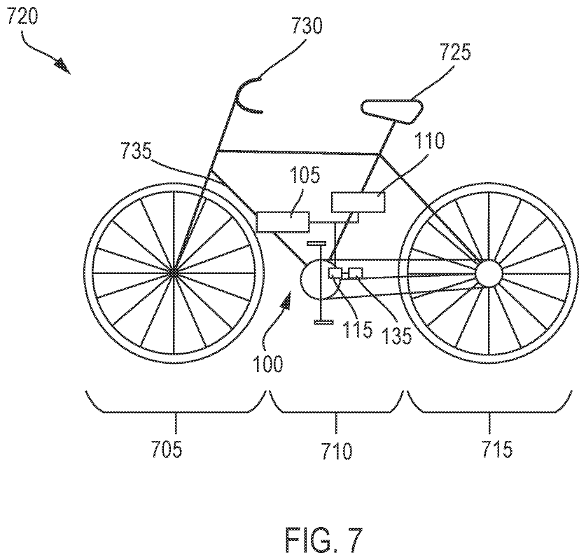

Referring now to FIG. 7, among others, an electric bicycle 720 including the system 100 that powers the motor 135 of the electric bicycle 720 with multiple batteries is shown. FIG. 7 depicts an example cross-sectional view of the electric bicycle 720 installed with at least one first battery 105 and at least one second battery 110. The electric bicycles 720 can be single rider bicycles, tandem bicycles, cargo bicycles, motor-assist bicycles, pedicabs, electric-assist bicycles, road bicycles, mountain bicycles, tricycles, or unicycles, among others. The first battery 105 or the second battery 110 can also be used as an energy storage system to power a building, such as a residential home or commercial building.

The electric bicycle 720 can be fully electric or partially electric (e.g., pedal-powered) and further, the electric bicycle 720 can be fully autonomous, partially autonomous, or unmanned. The electric bicycle 720 can also be human operated or non-autonomous. A human operator or the rider of the electric bicycle 720 can sit on a saddle 725 to operate the electric bicycle 720. The rider of the electric bicycle 720 can steer, grip, balance, or otherwise control the electric bicycle 720 using the handlebar 730.

The bicycle 720 can include a frame 735. The frame 735 can support various components of the electric bicycle 720, such as the handlebar 730, the saddle 725, the system 100, the battery 105, the battery 110, the controller 115, and/or the motor 135. The frame 735 can span a front portion 705. The front portion 705 can support, be coupled with, or include, for example, a front wheel of the bicycle 720, a fork of the bicycle 720, the handlebar 730, among other components. The bicycle 720 can include two or more wheels. The frame 735 can span a middle portion 710. The middle portion 710 can support, be coupled with, or include, for example, the saddle 725, the battery 105, the battery 110, the controller 115, the motor 135, a crank shaft of the bicycle 720, or a pedal of the bicycle 720, among other components. The frame 735 can include a rear portion 715. The rear portion 715 can support, be coupled with, or include, for example, a rear wheel of the bicycle 720, a drive train of the bicycle 720, or a rack of the bicycle 720, among other components.

The bicycle 720 can include batteries or battery packs 105 and 110, which can include batteries, battery modules, or battery cells power the bicycle 720. The batteries 105 and 110 can be installed or placed within the bicycle 720. For example, the batteries 105 and 110 can be installed on the frame 735 of the bicycle 720 within one or more of the front portion 705, the middle portion 710, or the rear portion 715. The battery 105 and 110 can include or connect with at least one busbar, e.g., a current collector element. For example, the busbar can include electrically conductive material to connect or otherwise electrically couple the battery 105 and 110 with other electrical components of the bicycle 720 to provide electrical power to various systems or components of the bicycle 720, such as a light source, a strobe light, a front light, and a rear light, an indicator, or a data processing system.

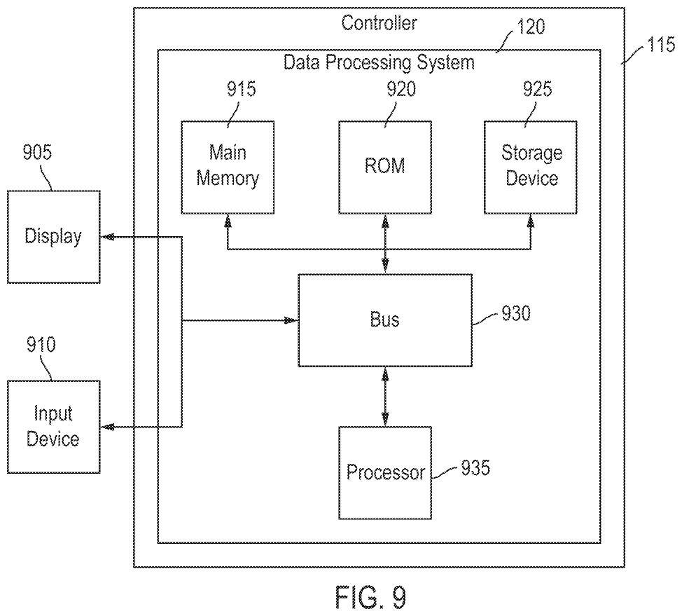

The bicycle 720 can provide a user interface, such as a graphical user interface or an audio-based user interface. The user interface can include, interface with, or otherwise utilize a touchscreen, keyboard, buttons, knobs, other user interface input devices or display depicted in FIG. 9, for example. Through the user interface, the rider of the bike can input one or more thresholds, view operating parameters of the bicycle 720, or control components of the bicycle 720, among other actions.

The controller 115 can cause the first battery 105 and the second battery 110 to simultaneously or concurrently provide power to the motor 135 to drive the motor 135. The motor 135 can be coupled with the front wheel or rear wheel of the bicycle 720 via a drive system, e.g., drive chain, gears, or other systems of the vehicle. The controller 115 can operate inverters to cause both the first battery 105 and the second battery 110 to provide power to two sets of coils of the motor 135. For example, the controller 115 can cause the first battery 105 to provide power to a first set of coils of the motor 135 and the second battery 110 to provide second power to a second set of coils of the motor 135. The controller 115 can operate the motor 135 with the power of the first battery 105 and the power of the second battery 110 to drive the front wheel of the bicycle 720 or the rear wheel of the bicycle 720. This can cause the front wheel or the rear wheel of the bicycle 720 to spin or rotate to assist the rider in pedaling the bicycle 720, or to cause the bicycle 720 to move without the rider pedaling the bicycle 720.

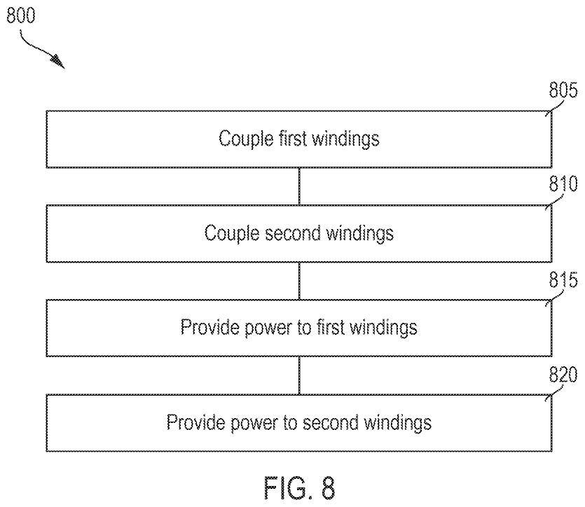

Referring now to FIG. 8, among others, a method 800 of operating a motor of a vehicle with multiple batteries is shown. At least a portion of the method 800 can be performed by the first battery 105, the second battery 110, the controller 115, the data processing system 120, the first inverter 125, the second inverter 130, the motor 135, the first winding set 140, and the second winding set 145. At least a portion of the method 800 can be performed by a processor, a microcontroller, a vehicle, the bicycle 720. At least a portion of the method 800 can be performed by a manufacturing system, apparatus, or device. At least a portion of the method 800 can be performed by a robotic assembly system, an automatic assembly system, a human operator, a technician, or a manufacturing individual. The method 800 can include an ACT 805 of coupling first windings. The method 800 can include an ACT 810 of coupling second windings. The method 800 can include an ACT 815 of providing power to first windings. The method 800 can include an ACT 820 of providing power to second windings.

At the ACT 805, the method 800 can including coupling the first windings 140. For example, the method 800 can include electrically coupling or connecting the first winding set 140 with the controller 115. For example, the method 800 can include coupling, via a wire, cable, or conductor, the first winding set 140 with the first inverter 125 of the controller 115. Furthermore, the method 800 can include coupling the first winding set 140 with the first battery 105. For example, the method 800 can include coupling, via a wire, cable, busbar, or conductor, the first inverter 125 with the first battery 105. By coupling the first battery 105 with the first inverter 125, and coupling the first inverter 125 with the first winding set 140, the first battery 105 and the first winding set 140 can be coupled and part of the same electric circuit or connection.

At the ACT 810, the method 800 can including coupling the second windings 145. For example, the method 800 can include electrically coupling or connecting the second winding set 145 with the controller 115. For example, the method 800 can include coupling, via a wire, cable, or conductor, the second winding set 145 with the second inverter 130 of the controller 115. Furthermore, the method 800 can include coupling the second winding set 145 with the second battery 110. For example, the method 800 can include coupling, via a wire, cable, busbar, or conductor, the second inverter 130 with the second battery 110. By coupling the second battery 110 with the second inverter 130, and coupling the second inverter 130 with the second winding set 144, the second battery 110 and the second winding set 145 can be coupled and part of the same electric circuit or connection.

At ACT 815, the method 800 can include providing power to the second windings 145. For example, the method 800 can include providing second power of the second battery 110 to the second set of windings 145. For example, the second inverter 130 can provide the second power of the second battery 110 to the second winding set 145. The second inverter 130 can receive DC power from the second battery 110, and output or generate second AC power and provide the second AC power to the second winding set 145. For example, the second inverter 130 can provide a second AC signal to the second winding set 145 to power the second winding set 145.

The second inverter 130 can provide the second power to the second winding set 145 during a time period, a length of time, or at a point in time. The first inverter 125 can provide second power to the second winding set 145 simultaneously or concurrently with the first inverter 125 providing the first power to the first winding set 140. In this regard, the second inverter 130 can also provide second power to the second winding set 145 during the time period, the length of time, or at the point in time. The method 800 can include providing a the motor 135 or providing the rotor 305 within the motor 135. The rotor 305 can be rotated by the first inverter 125 providing first power to the first winding set 140 and the second inverter 130 simultaneously providing the second power to the second winding set 145. By simultaneously providing the first power to the first winding set 140 and providing the second power to the second winding set 145, the first winding set 140 and the second winding set 145 can simultaneously or concurrently conduct current. Because both the first winding set 140 and the second winding set 145 simultaneously conduct current within a magnetic field of the motor 135 created by magnets 315 of the motor 135, the rotor 305 can rotate, spin, turn, or move based on power of the first battery 105 and the second battery 110.

FIG. 9 depicts an example block diagram of a controller 115. The controller 115 can include the data processing system 120. FIG. 9 depicts a computer system that can include or be used to implement a data processing system or its components. The data processing system 120 includes at least one bus 930 or other communication component for communicating information and at least one processor 935 or processing circuit coupled to the bus 930 for processing information. The data processing system 120 can also include one or more processors 935 or processing circuits coupled to the bus for processing information. The data processing system 120 can include at least one main memory 915, such as a random access memory (RAM) or other dynamic storage device, coupled to the bus 930 for storing information, and instructions to be executed by the processor 935. The main memory 915 can be used for storing information during execution of instructions by the processor 935. The data processing system 120 can further include at least one read only memory (ROM) 920 or other static storage device coupled to the bus 930 for storing static information and instructions for the processor 935. A storage device 925, such as a solid state device, magnetic disk or optical disk, can be coupled to the bus 930 to persistently store information and instructions.

The data processing system 120 may be coupled via the bus 930 to a display 905, such as a liquid crystal display, or active matrix display, for displaying information to a user such as a driver, rider, or user of the electric bicycle 720 or other end user. An input device 910, such as a keyboard or voice interface may be coupled to the bus 930 for communicating information and commands to the processor 935. The input device 910 can include a touch screen display 905. The input device 910 can also include a cursor control, such as a mouse, a trackball, or cursor direction keys, for communicating direction information and command selections to the processor 935 and for controlling cursor movement on the display 905.

The processes, systems and methods described herein can be implemented by the data processing system 120 in response to the processor 935 executing an arrangement of instructions contained in main memory 915. Such instructions can be read into main memory 915 from another computer-readable medium, such as the storage device 925. Execution of the arrangement of instructions contained in main memory 915 causes the data processing system 120 to perform the illustrative processes described herein. One or more processors in a multi-processing arrangement may also be employed to execute the instructions contained in main memory 915. Hard-wired circuitry can be used in place of or in combination with software instructions together with the systems and methods described herein. Systems and methods described herein are not limited to any specific combination of hardware circuitry and software.

Although an example computing system has been described in FIG. 9, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a first set of windings, coupled with a first battery via a first inverter;
a second set of windings, coupled with a second battery via a second inverter;
the first inverter configured to provide first power of the first battery to the first set of windings during a time period; and
the second inverter configured to provide second power of the second battery to the second set of windings during the time period.

2. The apparatus of claim 1, wherein:
the first inverter is configured to provide the first power to the first set of windings and the second inverter is configured to simultaneously provide the second power to the second set of windings.

3. The apparatus of claim 1, comprising:
the first inverter configured to provide the first power of the first battery to the first set of windings for a duration of the time period; and
the second inverter configured to provide the second power of the second battery to the second set of windings for the duration of the time period.

4. The apparatus of claim 1, comprising:
a rotor configured to rotate responsive to a first current that flows through the first set of windings and a second current that simultaneously flows through the second set of windings.

5. The apparatus of claim 1, comprising:
a stator comprising a slot, wherein at least a portion of the first set of windings and at least a portion of the second set of windings are wound in the slot.

6. The apparatus of claim 1, comprising:
a stator comprising a member;
a first winding of the first set of windings wound around the member over a first section of the member; and
a second winding of the second set of windings wound around the member over a second section of the member.

7. The apparatus of claim 1, comprising:
a stator comprising a member;
a first winding of the first set of windings wound around the member over a section of the member; and
a second winding of the second set of windings wound around the member over the section of the member.

8. The apparatus of claim 1, comprising:
a stator comprising a member,
wherein a first winding of the first set of windings is wound around the member over a first section of the member, wherein the first section is a first distance from an end of the member; and
wherein a second winding of the second set of windings is wound around the member over a second section of the member, wherein the second section is a second distance from the end of the member.

9. The apparatus of claim 1, comprising:
a first stator, wherein the first set of windings are wound on the first stator; and
a second stator, wherein the second set of windings are wound on the second stator;
wherein the first set of windings is configured to conduct first current and the second set of windings is configured to simultaneously conduct second current to rotate a rotor.

10. The apparatus of claim 1, comprising:
a first stator comprising a first longitudinal axis, wherein the first set of windings are wound on the first stator; and
a second stator comprising a second longitudinal axis, wherein the second set of windings are wound on the second stator;
wherein the first longitudinal axis and the second longitudinal axis are aligned.

11. The apparatus of claim 1, comprising:
a controller configured to control the first inverter and the second inverter to simultaneously provide power to the first set of windings and the second set of windings.

12. The apparatus of claim 1, comprising:
the first set of windings comprising wire of a first gauge; and
the second set of windings comprising second wire of a second gauge different than the first gauge.

13. The apparatus of claim 1, comprising:
the first inverter configured to provide the first power to the first set of windings and the second inverter configured to provide the second power to the second set of windings when:
the first battery and the second battery are at the same state of charge; and
the first battery and the second battery are at different states of charge.

14. The apparatus of claim 1, comprising:
a controller to:
operate the first inverter to provide the first power of the first battery to the first set of windings to cause a motor to provide a first torque and provide a first range for a vehicle;
determine, based on a first characteristic of the first battery and a second characteristic of the second battery, a first frequency of a first signal of the first battery to provide to the first set of windings and a second frequency of the second signal of the second battery to simultaneously provide to the second set of windings to increase the first torque to a second torque or increase the first range to a second range;
operate the first inverter to provide the first frequency of the first signal of the first battery to the first set of windings; and
operate the second inverter to provide the second frequency of the second signal of the second battery to the second set of windings.

15. A method, comprising:
coupling a first set of windings with a first battery via a first inverter;
coupling a second set of windings with a second battery via a second inverter;
providing, by the first inverter, first power of the first battery to the first set of windings during a time period; and
providing, by the second inverter, second power of the second battery to the second set of windings during the time period.

16. The method of claim 15, comprising:
simultaneously providing, by the first inverter, the first power to the first set of windings and providing, by the second inverter, the second power to the second set of windings.

17. The method of claim 15, comprising:
providing a rotor to rotate responsive to a first current flowing through the first set of windings and a second current that simultaneously flows through the second set of windings.

18. A motor, comprising:
a first set of windings, coupled with a first battery via a first inverter, the first set of windings to receive first power of the first battery from the first inverter during a time period; and
a second set of windings, coupled with a second battery via a second inverter, the second set of windings to receive second power of the second battery from the second inverter during the time period.

19. The motor of claim 18, comprising:
a stator comprising a slot, wherein at least a portion of the first set of windings and at least a portion of the second set of windings are wound in the slot.

20. The motor of claim 18, comprising:
a first stator, wherein the first set of windings are wound on the first stator; and
a second stator, wherein the second set of windings are wound on the second stator;
wherein the first set of windings configured to conduct first current and the second set of windings configured to simultaneously conduct second current to rotate a rotor.
